(19) United States
(12) Patent Application Publication
(10) Pub. No.: US 2013/0157921 A1
(43) Pub. Date: Jun. 20, 2013

(54) ACIDIC GEL CLEANER WITH IMPROVED RINSING FROM A DRIED STATE

(71) Applicants: Brenda C. Marin, Phoenix, AZ (US); Joan M. Bergstrom, Scottsdale, AZ (US)

(72) Inventors: Brenda C. Marin, Phoenix, AZ (US); Joan M. Bergstrom, Scottsdale, AZ (US)

(73) Assignee: The Dial Corporation, Scottsdale, AZ (US)

(21) Appl. No.: 13/327,084

(22) Filed: Dec. 15, 2011

(51) Int. Cl. C11D 17/00

(52) U.S. Cl. 510/403

(57) ABSTRACT

The rinsing performance of acidic gel cleaners comprising acid, surfactant and water is improved using a synergistic combination of two polymers consisting essentially of (a) copolymer having a quaternized monomer and (b) microbially-derived polysaccharide. In a preferred embodiment of the invention, the acidic gel cleaner includes (a) a copolymer having at least a diallyldimethylammonium chloride monomer or an acrylamidopropyltrimethylammonium chloride monomer, and (b) xanthan gum. The improved gel cleaners have the unique ability to be easily rinsed from a hard surface even if previously dried into a dry mass on the hard surface.

### FIELD OF THE INVENTION

The present invention generally relates to acidic cleaners in gel form and more particularly to an acidic gel cleaner that can be quickly rinsed off from a hard surface if dried thereon. The present invention also relates to a method for improving the rinsing properties of acidic gel cleaners.

### BACKGROUND OF THE INVENTION

Acid cleaners are well known both in the literature and in the retail and institutional cleaning markets. Thickened acid cleaners are mostly embodied in the market as toilet bowl cleaners, although some acid cleaners are marketed as all purpose or bathroom cleaners. Some of the more relevant art is discussed below.

U.S. Pat. No. 6,153,572 (Stamm) discloses a thickened acid toilet bowl cleaner comprising organic acid (e.g. glycolic acid), a nonionic surfactant, and a thickener such as an acrylic copolymer, xanthan gum, cellulose derivatives, or polysaccharides.

U.S. Pat. No. 6,239,092 (Papasso et al.) discloses an acid cleaner comprising organic acid, quaternary germicide, and a cellulosic thickener such as hydroxyethyl cellulose.

U.S. Pat. No. 6,683,035 (Koester et al.) discloses a gel cleaner comprising an alkoxylated carboxylic acid ester surfactant. The gel is thickened with a polysaccharide such as xanthan or guar gum.

U.S. Patent Application Publication No. US2011/0061680 (Davister et al.) discloses an acidic cleaner comprising organic acid, nonionic surfactant and a surface-modifying hydrophilic polymer such as a polybetaine. The cleaning composition may be thickened with a polysaccharide.

U.S. Patent Application Publication No. US2003/083223 (Aubay et al.) discloses an amphoteric polymer for use in a hard surface cleaner. The application discloses compositions that comprise acid, surfactant and the inventive amphoteric polymer, and further disclose that such compositions may optionally include thickeners such as a cellulose or guar derivative.

Lastly, PCT Application Publication No. WO 2007/022235 (Dastbaz) discloses an acidic cleaning composition comprising a hydrophilizing polymer, a surfactant, and an acid, with no mention of thickeners or any viscosity target.

A problem that at least to our knowledge has never been addressed, is how to improve the rinsing of an acidic gel cleaner that has been left to dry out on a hard surface. If a thickened acid cleaner, such as a toilet bowl cleaner, is left to dry on a hard surface, the solidified remains will be extremely difficult to rewet and remove because of the dehydration of any hydrophilic ingredients and the general inability for tap water to penetrate the dried surface. Such drying out is not only possible, but also probable, and may happen if the consumer is distracted and leaves the cleaning chore unfinished.

Accordingly, it is desirable to discover ingredient combinations that may improve the rinsing of a dried-on acidic gel cleaner. In addition, it is desirable to find a general method to improve the rinsing of acidic gel cleaners in both normal use and when accidentally dried onto a hard surface. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

It has now been surprisingly discovered that particular combinations of copolymer and polysaccharide drastically improve the speed of removal of a dried-on gel hard surface cleaner.

In an embodiment of the present invention, a combination of a copolymer having at least one quaternized monomer and a microbially-derived polysaccharide dramatically improves the rinsing of an acidic gel cleaner comprising acid, surfactant, and water.

In an additional embodiment of the present invention, a combination of a diallyldimethylammonium chloride/acrylamide/acrylic acid copolymer and a microbially-derived polysaccharide accelerates the removal time for a dried-on acid gel cleaner comprising organic acid, surfactant, and water.

In an additional embodiment of the present invention, a combination of a hydrophobically-modified amphoteric copolymer having at least one quaternized monomer and a microbially-derived polysaccharide accelerates the removal time for a dried-on acid gel cleaner comprising organic acid, surfactant, and water.

In an additional embodiment of the present invention, a diallyldimethylammonium chloride/acrylic acid/dimethylacrylamide/(meth)acrylamide copolymer, in combination with a microbially-derived polysaccharide, accelerates the removal time for a dried-on acid gel cleaner comprising organic acid, surfactant, and water.

In an additional embodiment of the present invention, a combination of an acrylamidopropyltrimethylammonium chloride/sodium acrylate/ethyl acrylate copolymer and a microbially-derived polysaccharide accelerates the removal time for a dried-on acid gel cleaner comprising organic acid, surfactant, and water.

In a preferred embodiment of the present invention, an approximate 1.5:1 to 2:1 ratio of: (a) a copolymer selected from the group consisting of diallyldimethylammonium chloride/acrylamide/acrylic acid copolymer, diallyldimethylammonium chloride/acrylic acid/dimethylacrylamide/(meth)acrylamide copolymer, and acrylamidopropyl trimethylammonium chloride/sodium acrylate/ethyl acrylate copolymer; to (b) a microbially-derived polysaccharide, incorporated into an acidic gel cleaner comprising acid, surfactant, and water, markedly improves the ability to remove the gel cleaner if it has been dried on a hard surface.

In another embodiment of the present invention, a method is provided for improving the rinsing characteristics of an acidic gel hard surface cleaner comprising acid, surfactant, and water, said method comprising the steps of (a) providing an acidic mixture of acid, surfactant and water (such as available from an already finished retail bath/bowl cleaner) and (2) adding to the mixture or retail bath/bowl cleaner a combination of (i) a copolymer having at least one quaternized monomer; and (ii) a microbially-derived polysaccharide. The new and improved acidic gel cleaner will be easily removable from a hard surface using cold tap water even if it is inadvertently dried onto the hard surface.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In general, the present invention is an acidic gel cleaner that is easily removed if it happens to be dried onto a hard surface such as the inside of a toilet bowl above the water line. The improved rinsing from the dried-on state is possible through a combination of copolymer and polysaccharide. The acid gel cleaner also comprises an acid component, at least one surfactant, and water, and may optionally comprise alkaline pH buffers, other polymers, builders, chelants, solvents, dyes, pigments, fragrances, and preservatives. Preferably the inventive gel cleaner includes only the combination of copolymer and polysaccharide to achieve both a viscous product and the improved rinsing characteristics, without the need for any other polymers that may affect viscosity. The compositions are preferably gel-like in structure, as defined in Römpp Lexikon Chemie, 10th edition, Stuttgart/New York, 1997.

Acid Component

The acidic gel cleaner of the present invention necessarily comprises at least one organic or inorganic acid, mixtures of organic acids, mixtures of inorganic acids, or various combinations of organic and inorganic acids, in order to render the composition below pH 7, and preferably below pH 3, when measured without dilution (i.e. “as is”). The organic or inorganic acids for use in the present invention may be any known to those skilled in the art of specialty chemicals and detergents, however, it is preferred to use at least one organic acid. It may be useful to use a mixture of a weak and a strong organic acid (e.g., citric acid and methane sulfonic acid), a weak and a strong inorganic acid (e.g., nitric, sulfuric, sulfamic, and phosphoric acid), or a single strong inorganic acid (e.g. hydrochloric acid). Most preferred is to use a single organic acid, with that acid selected from the group consisting of citric, lactic, oxalic, formic, glycolic, and mixtures thereof. Other organic and inorganic acids that may find use in the present invention include, but are not limited to, maleic acid, sorbic acid, benzoic acid, p-hydroxybenzoic acid, glutaric acid, ethylenediaminetetraacetic acid, polyphosphoric acid, aspartic acid, acetic acid, hydroxyacetic acid, propionic acid, hydroxypropionic acid, α-ketopropionic acid, butyric acid, mandelic acid, valeric acid, succinic acid, tartaric acid, malic acid, fumaric acid, adipic acid, and mixtures thereof.

The selection of acid(s) usually becomes a four-way balance between safety (i.e. skin, eye, and surface corrosion), cost, odor, and cleaning efficiency (i.e., ability to dissolve hard water deposits, precipitated soap scum, and rust). The combination of citric acid, phosphoric acid, and methane sulfuric acid, surprisingly, results in an increase in cleaning efficacy, as well as the combination of just citric and formic acids together. Balancing safety, cost, odor, and cleaning efficacy, the more preferred acids for the present invention are lactic acid, citric acid, formic acid, sulfamic acid, glycolic acid, oxalic acid, and mixtures thereof. It is most preferred to incorporate lactic or citric acid alone, or a mixture of the two, at a total level of from about 0.5% to about 10% by weight, based on the total weight of the composition. The amount of acid may be chosen to achieve a low pH such as less than 2, or less than 1, and then adjusted with an amount of optional alkali sufficient to bring the pH of the final composition to less than about pH 7, and more preferably less than about pH 3. Most preferably, the final pH of the gel composition is adjusted to be between about pH 2-3 by a combination of at least one organic acid and at least one alkaline agent (discussed below).

Surfactants

The present acidic gel cleaner necessarily includes at least one surfactant. The surfactant component to the composition is chosen from the group consisting of anionic surfactants, nonionic surfactants, cationic surfactants, amphoteric surfactants, and mixtures thereof. In these preferred groups of surfactants, it is important to note that more than one subgroup of surfactants may exist, and may be useful in the present invention. For example, the gel may include both an alkylpolyglycoside (APG) and ethoxylated alcohol, both “nonionic surfactants” in the broadly selected group of surfactants. As alternate non-limiting examples, the composition may include both a nonionic surfactant and an anionic surfactant, or perhaps a nonionic surfactant and an amphoteric surfactant. It is also important to note that some anionic surfactants may be partly or entirely neutralized in the acidic composition. Also, some amphoteric surfactants may be partly or entirely shifted to cationic species in the acidic composition. No attempt is made to quantify the surfactant species that may be present after mixing of the final composition. Only the ingredients added are the subject of the present invention.

Nonionic Surfactants

Most preferred for use as a nonionic surfactant in the present gel cleaner are the alkyl polyglycoside surfactants. The alkyl polyglycosides (commonly referred to as APG's), also called alkyl polyglucosides if the saccharide moiety is glucose, are naturally derived, nonionic surfactants. The alkyl polyglycosides that may be used in the present invention are fatty ester derivatives of saccharides or polysaccharides that are formed when a carbohydrate is reacted under acidic conditions with a fatty alcohol through condensation polymerization. The APG's are typically derived from corn-based carbohydrates and fatty alcohols from natural oils found in animals, coconuts and palm kernels. Such methods for deriving APG's are well known in the art. The alkyl polyglycosides that are preferred for use in the present invention contain a hydrophilic group derived from carbohydrates and is composed of one or more anhydroglucose units. Each of the glucose units may have two ether oxygen atoms and three hydroxyl groups, along with a terminal hydroxyl group, which together impart water solubility to the glycoside. The presence of the alkyl carbon chain leads to the hydrophobic tail of the molecule.

When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of glucose units (i.e., degree of polymerization).

The APG's that may be used in the present invention preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APG's, x may be a non-integer on an average basis when referred to particular APG's of use as an ingredient for the detersive composition of the present invention. For the APG's preferred for use herein, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6.

Commercially available alkyl polyglycoside can be obtained as concentrated aqueous solutions ranging from 50 to 70% actives and are available from Cognis. Most preferred for use in the present compositions are APG's with an average degree of polymerization of from 1.4 to 1.7 and the chain lengths of the aliphatic groups are between C₈ and C₁₆. For example, one preferred APG for use herein has chain length of C₈ and C₁₀ (ratio of 45:55) and a degree of polymerization of 1.7. The acidic gel cleaner composition preferably includes a sufficient amount of alkyl polyglycoside surfactant in an amount that provides a desired level of cleaning of soils found on hard surfaces in homes and institutions. Preferably, the cleaning composition includes between about 0.01% and about 10% by weight alkyl polyglycoside surfactant based on the total weight of the composition. More preferably, the composition incorporates Glucopon® APG® 325N or Glucopon® 215 CS from Cognis at between about 0.01% and about 10% by weight active alkyl polyglucoside surfactant to the total aqueous composition, and most preferably between about 0.1% and 5% by weight actives.

Also useful in the acid cleaner composition of the present invention are nonionic surfactants such as the ethoxylated and/or propoxylated primary alcohols having 9 to 18 carbon atoms and on average from 4 to 12 moles of ethylene oxide (EO) and/or from 1 to 10 moles of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 4 to about 12 EO per mole of alcohol. Most useful as nonionic surfactants in the present invention include the C₉-C₁₁ alcohol ethoxylates, the C₁₂-C₁₃ ethoxylates, the C₁₂-C₁₅ ethoxylates, and the C₁₂-C₁₄ alcohol ethoxylates, any of which ethoxylated with 4-12 moles EO, incorporated at from about 0.01% to about 10% total active surfactant. Combinations of more than one alcohol ethoxylate surfactant may also be desired in the acid gel composition in order to maximize cleaning of various home and institutional surfaces. Alcohol ethoxylate nonionic surfactants are preferably incorporated at a level of from about 0.01% to about 10% by weight and most preferably from about 0.1% to about 5% by weight of the total composition.

The acidic gel composition of the present cleaning system may also include an amide type nonionic surfactant, for example alkanolamides that are condensates of fatty acids with alkanolamines such as monoethanolamine (MEA), diethanolamine (DEA) and monoisopropanolamine (MIPA), that have found widespread use in cosmetic, personal care, household and industrial formulations. Useful alkanolamides include ethanolamides and/or isopropanolamides such as monoethanolamides, diethanolamides and isopropanolamides in which the fatty acid acyl radical typically contains from 8 to 18 carbon atoms. Especially satisfactory alkanolamides have been mono- and diethanolamides such as those derived from coconut oil mixed fatty acids or special fractions containing, for instance, predominately C₁₂ to C₁₄ fatty acids. For most applications, alkanolamides prepared from trialkylglycerides are considered most practical due to lower cost, ease of manufacturing and acceptable quality. Of use in the present invention are mono- and diethanolamides derived from coconut oil mixed fatty acids, (predominately C₁₂ to C₁₄ fatty acids). If used in the present cleaner, the amide surfactants are preferably incorporated at a level of from about 0.01% to about 10% and most preferably from about 0.1% to about 5% by weight in the aqueous composition.

Lastly, another nonionic surfactant that may find use in the present cleaning composition is an amine oxide surfactant. Preferred amine oxides comprise the general formula R¹R²R³N⁺—O⁻, where R¹ is a C₆₋₃₀ alkyl, and R² and R³ are C₁₋₆ alkyl or hydroxyalkyl, and where R² and R³ may be the same or different substituents on the nitrogen. Preferred amine oxide surfactants include, but are not limited to, alkyl di-(hydroxy lower alkyl) amine oxides, alkylamidopropyl di-(lower alkyl) amine oxides, alkyl di-(lower alkyl) amine oxides, and/or alkylmorpholine N-oxides, wherein the alkyl group has 5-25 carbons and may be branched, straight-chain, saturated, and/or unsaturated. The most preferred amine oxides for the present invention include, but are not limited to, lauryl dimethyl amine oxide sold as aqueous solutions under the name Barlox® 12 from Lonza and under the brand name Ammonyx® LO from Stepan. If used herein, the amine oxide surfactants are preferably incorporated at a level of from about 0.01% to about 10% and most preferably from about 0.1% to about 5% by weight, based on the total weight of the gel composition.

Anionic Surfactant

The present acidic cleaner composition may optionally include one or more anionic surfactants to assist with cleaning soiled hard surfaces in homes and institutions. It is understood that in the acidic conditions of the composition (most preferably between a pH of about 2 to about 3), anionic surfactants (such as R—SO₃⁻Na⁺ for example) are likely to exist in both their protonated/acid form (R—SO₃H for example) and their deprotonated/salt form (such as R—SO₃⁻Na⁺ for example). For purposes of the present invention and disclosure of best mode, it is not necessary to attempt to find the dissociation constant for each of the preferred anionic surfactants used, or attempt to quantify the final ratio of protonated/acid form to deprotonated/salt form in solution for any of the anionic surfactants used herein. It is understood that the weight percentages of anionic surfactant discussed below as preferred for the present compositions is the amount of either form of the surfactant since the molecular weights of the protonated/acid form and the deprotonated/salt form for any of these large surfactants are close enough that little differences would result by strictly adding only one pure form or the other into the batch. Most of the anionic surfactants are more readily available and perhaps easier to handle when in their deprotonated/salt form, except for perhaps dodecylbenzene sulfonic acid (LAS acid), which although it is quite viscous, is often used in manufacturing detergents.

Suitable anionic surfactants include the sulfonate and sulfate types. Preferred surfactants of the sulfonate type are C₉₋₁₃ alkylbenzenesulfonates, olefinsulfonates, hydroxyalkanesulfonates and disulfonates, as are obtained, for example, from C₁₂₋₁₈ monoolefins having a terminal or internal double bond by sulfonating with gaseous sulfur trioxide followed by alkaline or acidic hydrolysis of the sulfonation products. Anionic surfactants that are preferred for use in the acidic gel compositions of the present invention include the alkyl benzene sulfonate salts. Suitable alkyl benzene sulfonates include the sodium, potassium, ammonium, lower alkyl ammonium and lower alkanol ammonium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, useful for the acidic compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft® LPS-99 or Calsoft® TSA-99 marketed by Pilot Chemical. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Also of use in the present invention are the ammonium salts, lower alkyl ammonium salts and the lower alkanol ammonium salts of linear alkyl benzene sulfonic acid, such as triethanol ammonium linear alkyl benzene sulfonate including Calsoft® T-60 sold by Pilot Chemical. The preferred level of sulfonate surfactant in the present invention is from about 0.1% to about 20%. More preferred is to use sodium dodecylbenzene sulfonate, such as Bio Soft® D-40 from Stepan or Calsoft® L40 from Pilot, at a level of from about 0.1% to about 10%, and most preferred at from about 0.5% to about 5% by weight actives, based on the total weight of the composition.

Also with respect to other optional anionic surfactants useful in the acidic gel cleaner compositions herein, the alkyl ether sulfates, also known as alcohol ether sulfates, are preferred. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₂₁ alcohol ethoxylated with from about 0.5 to about 9 mol of ethylene oxide (x=0.5 to 9 EO), such as C₁₂-C₁₈ alcohols containing from 0.5 to 9 EO, and where M is alkali metal or ammonium, alkyl ammonium or alkanol ammonium counterion. Preferred alkyl ether sulfates include C₈-C₁₈ alcohol ether sulfates with a degree of ethoxylation of from about 0.5 to about 9 ethylene oxide moieties and most preferred are the C₁₂-C₁₅ alcohol ether sulfates with ethoxylation from about 4 to about 9 ethylene oxide moieties, with 7 ethylene oxide moieties being most preferred. It is understood that when referring to alkyl ether sulfates, these substances are already salts (hence designated “sulfonate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. For example, sodium lauryl ether sulfate (“sodium laureth sulfate”, having about 3 ethylene oxide moieties) is very readily available commercially and quite common in shampoos and detersives, however, this is not the preferred level of ethoxylation for use in the present invention for hard surface cleaning. Therefore it may be more practical to sulfonate a commercially available nonionic surfactant such as Neodol® 25-7 Primary Alcohol Ethoxylate (a C₁₂-C₁₅/7EO nonionic from Shell) to obtain the C₁₂-C₁₅/7EO alkyl ether sulfate that may have been difficult to source commercially. The preferred level of C₇-C₂₁/0.5-9EO alkyl ether sulfate in the present invention is from about 0.01% to about 10% weight percent actives. Most preferred is to incorporate sodium lauryl ether sulfate at from about 0.1% to about 5% by weight actives, based on the total weight of the composition.

Other anionic surfactants that may be included in the acidic gel compositions herein include the alkyl sulfates, also known as alcohol sulfates. These surfactants have the general formula R—O—SO₃Na where R is from about 8 to 18 carbon atoms, and these materials may also be denoted as sulfuric monoesters of C₈-C₁₈ alcohols, examples being sodium n-octyl sulfate, sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detersives standpoint, C₁₂-C₁₆-alkyl sulfates, C₁₂-C₁₅-alkyl sulfates, and also C₁₄-C₁₅ alkyl sulfates, are all preferred. Most preferred is to use sodium lauryl sulfate from the Stepan Company sold under the trade name of Polystep®. The preferred level of alcohol sulfate in the present invention is from about 0.01% to about 10%. Most preferred is to incorporate sodium lauryl sulfate, such as Calfoam® SLS-30, at from about 0.1% to about 5% by weight actives to the total composition.

Fatty soaps may also be incorporated into the detersive composition as an anionic detersive component as these are particularly suitable to aid in fat and oil removal from shower/tub/enclosure surfaces be it natural oils or residues from shampoo, conditioner and moisturizers. As used here, “fatty soap” means the salts of fatty acids. For example, the fatty soaps that may be used here have general formula R—CO₂M, wherein R represents a linear or branched alkyl or alkenyl group having between about 8 and 24 carbons and M represents an alkali metal such as sodium or potassium or ammonium or alkyl- or dialkyl- or trialkyl-ammonium or alkanol-ammonium cation. The fatty acid soaps suitable for emulsifying similar soap residues on bathroom surfaces, is preferably comprised of higher fatty acid soaps. That fatty acids that may be the feed stock to the fatty soaps may be obtained from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Fatty acids can be synthetically prepared, for example, by the oxidation of petroleum, or by hydrogenation of carbon monoxide by the Fischer-Tropsch process. The fatty acids of particular use in the present invention are linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids and their preferred salts (soaps) are alkali metal salts, such as sodium and potassium or mixtures thereof. Other useful soaps are ammonium and alkanol-ammonium salts of fatty acids. The fatty acids that may be included in the present compositions will preferably be chosen to have desirable surface cleaning efficacy and foam regulation. The preferred level of fatty soap in the present invention is from about 0.01% to about 10%. Most preferred is from about 0.1% to about 5%.

Additional anionic surfactants that may find use in the compositions of the present invention include the alpha-sulfonated alkyl esters of C₁₂-C₁₆ fatty acids. The alpha-sulfonated alkyl esters may be pure alkyl ester or a blend of (1) a mono-salt of an alpha-sulfonated alkyl ester of a fatty acid having from 8-20 carbon atoms where the alkyl portion forming the ester is straight or branched chain alkyl of 1-6 carbon atoms and (2) a di-salt of an alpha-sulfonated fatty acid, the ratio of mono-salt to di-salt being at least about 2:1. The alpha-sulfonated alkyl esters useful herein are typically prepared by sulfonating an alkyl ester of a fatty acid with a sulfonating agent such as SO₃. When prepared in this manner, the alpha-sulfonated alkyl esters normally contain a minor amount, (typically less than 33% by weight), of the di-salt of the alpha-sulfonated fatty acid which results from saponification of the ester. Preferred alpha-sulfonated alkyl esters contain less than about 10% by weight of the di-salt of the corresponding alpha-sulfonated fatty acid.

The alpha-sulfonated alkyl esters, i.e., alkyl ester sulfonate surfactants, include linear esters of C₆-C₂₂ carboxylic acids that are sulfonated with gaseous SO₃. Suitable starting materials preferably include natural fatty substances as derived from tallow, palm oil, etc., rather than from petroleum sources. The preferred alkyl ester sulfonate surfactants, especially for a detersive composition for the present invention, comprise alkyl ester sulfonate surfactants of the structural formula R³—CH(SO₃M)-CO₂R⁴, wherein R³ is a C₈-C₂₀ hydrocarbon chain preferably naturally derived, R⁴ is a straight or branched chain C₁-C₆ alkyl group and M is a cation which forms a water soluble salt with the alkyl ester sulfonate, including sodium, potassium, magnesium, and ammonium cations. Preferably, R³ is C₁₀-C₁₆ fatty alkyl, and R⁴ is methyl or ethyl. Most preferred are alpha-sulfonated methyl or ethyl esters of a distribution of fatty acids having an average of from 12 to 16 carbon atoms. For example, the alpha-sulfonated esters Alpha-Step® BBS-45, Alpha-Step® MC-48, and Alpha-Step® PC-48, all available from the Stepan Co. of Northfield, Ill., may find use in the present invention. Alpha-sulfonated fatty acid ester surfactants may be used at a level of from about 0.01% to about 10% and most preferably at a level of from about 0.1% to about 5% by weight actives to the total composition.

Amphoteric Surfactant

The acidic gel cleaner of the present invention may also include one or more amphoteric surfactants. Preferred amphoteric surfactants include the alkylbetaines of the general formula R¹—N⁺(CH₃)₂—CH₂COO⁻, the alkylamidobetaines of the general formula R¹—CO—NH—(CH₂)₃—N⁺(CH₃)₂—CH₂COO⁻, the sulfobetaines of the general formula R¹—N⁺(CH₃)₂—CH₂CH(OH)CH₂SO₃⁻, and the amidosulfobetaines of the general formula R¹—CO—NH—(CH₂)₃—N⁺(CH₃)₂—CH₂CH(OH)CH₂SO₃⁻, in which R¹ is a saturated or unsaturated C₆₋₂₂-alkyl radical, preferably C₈-C₁₈-alkyl radical, and in particular a saturated C₁₀₋₁₆-alkyl radical. A preferred example for R¹ is a saturated C₁₂₋₁₄-alkyl radical. Examples of suitable betaines and sulfobetaines include, but are not limited to, the following compounds named in accordance with INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidoprbpyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. The preferred betaine for use in the present acidic cleaner includes hydroxyethyl tallow betaine, such as Mona™ AT-1200 from Croda or Mackam™ TM from Rhodia Novecare. The preferred level of amphoteric surfactant in the present invention is from about 0.01% to about 10% by weight. Most preferred is to incorporate hydroxyethyl tallow glycinate, such as Mackam™ TM, at from about 0.1% to about 5% by weight active surfactant to the total weight of the composition.

Inventive Polymer Combination

The present gel cleaner composition and method for improving the rinsing of an acidic gel cleaner that has been dried onto a hard surface, comprises a combination of polymers consisting essentially of (a) a copolymer having at least one quaternized monomer and (b) a microbially-derived polysaccharide. As discussed below, the two types of polymers, (a) and (b), must be present together for the synergistic effect on rinsing performance to exist. When the amounts of each are optimized for rinse performance, the resulting viscosity of the composition is from about 100 to about 5000 cps (Brookfield).

Copolymers Having at Least One Quaternized Monomer

The improvement in rinsing of a dried-on acidic gel cleaner requires the presence of a copolymer having at least one quaternized monomer. Copolymers having at least one quaternized monomer is a group of copolymers (with random structure or any conceivable block structure) having at least one monomer that comprises a quaternized positively-charged nitrogen atom and a negatively charged counterion. Quaternized nitrogen is known in the chemical arts to be a nitrogen atom having four substituents and a concomitant permanent positive charge, i.e. R¹R²R³R⁴N⁺X⁻, where none of substituents R¹ R² R³ or R⁴ is hydrogen. However, the at least one monomer having the quaternized nitrogen substituent may also have other functional groups in the same monomer structure, including but not limited to amino, hydroxyl, amido, carboxy, ether, thioether, oxo, etc. By way of a non-limiting example, a copolymer formed from at least one monomer having the following chemical structure:

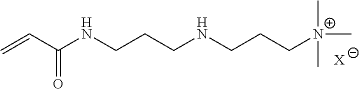

fits the present definition of a copolymer having at least one quaternized monomer, even though this particular monomer also has a secondary amine group that may or may not be protonated and positively charged. That is, so long as a quaternized nitrogen group is present in the monomer, the at least one quaternized monomer may also include an amino group that may be neutral or positively charged by protonation, or any other conceivable functional group for that matter. It is also conceivable that the quaternized monomer may have any net charge depending on what other functional groups are present in the quaternized monomer and what the pH of the composition is that the copolymer is added into. It should also be understood that copolymers having at least one quaternized monomer do not necessarily have to be cationic in overall charge. That is, a copolymer for use here, having at least one quaternized monomer, need not be a cationic copolymer at all, even though the at least one quaternized monomer may by itself have a net positive charge. Copolymers having at least one quaternized monomer include copolymers that are overall cationic, nonionic, anionic, and even amphoteric, as determined by the molar ratio of the various cationic, nonionic, or anionic monomer options, and the final pH of the composition comprising the copolymer. The only limitation of the copolymer for use herein is that it includes at least one quaternized monomer, meaning a quaternary nitrogen group. The remaining monomers of the copolymer may comprise any number of functional groups with various charges, which may change in character between cationic, nonionic, and/or anionic character due to the pH of the final composition. The remaining monomers are copolymerizable with the quaternized monomer. For example, the remaining monomers may be (meth)acrylate and derivatives, (meth)acrylamide and derivatives, or any other monomer with a polymerizable olefinic structure such as vinyl acetate, vinyl alcohol, vinyl pyrrolidone, and the like. The use of the trivial name “(meth)acrylic” is meant to include both methacrylic substances, such as methacrylic acid, and acrylic substances, such as acrylic acid, as is customarily used for trivial nomenclature in the polymer arts. The copolymers for use herein may be optionally cross-linked.

Preferred for use in the present invention, and included within this group of copolymers having at least one quaternized monomer, are the copolymers comprising at least one type of quaternized monomer that carries two polymerizable olefin residues, such as diallyldimethylammonium chloride (DADMAC) and/or its derivatives.

Preferred copolymers include those copolymers formed from at least one monomer having the general formula (I);

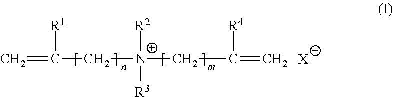

wherein R¹ and R⁴ independently represent a hydrogen atom or a linear or branched C₁-C₆ alkyl group;
R² and R³ independently represent an alkyl, hydroxy alkyl, or amino alkyl group, in which the alkyl group is a linear or branched C₁-C₆ chain, preferably a methyl group;
n and m independently represent integers between 1 and 3; and
X represents a negatively-charged counterion such as halide, alkyl sulfate, or aryl sulfonate.

DADMAC is the simplest in this family of quaternized monomers, the structure of which is general formula (I) with R¹ and R⁴ hydrogen, R² and R³ methyl, n and m the integer 1, and X chloride. A very useful copolymer comprises a monomer of general structure (I) copolymerized with at least one hydrophilic monomer having an ionizable acid functionality (such as (meth)acrylic acid) and, optionally, with at least one hydrophilic monomer having olefinic unsaturation and overall neutral charge (such as (meth)acrylamide). Such copolymers have the trivial name of diallyldimethylammonium chloride/acrylamide/acrylic acid copolymer. Most preferred is to use a copolymer wherein the ratio of monomers (I) to the ionizable acid monomers is between 60/40 and 5/95. Such copolymers are presently available from Rhodia under the trade name Mirapol® Surf-S. These copolymers are also referred to as hydrophilizing polymers in the context of surface modification and “easier next time cleaning,” although these polymers have not been used to improve the rewetting and rinsing off of dried-on cleaners, or that they could even influence the rinsing of cleaners dried onto “untreated” hard surfaces (i.e. when the cleaner is used the first time and left to dry on the surface). The polymers in this class that find particular use in the present invention are the copolymers disclosed in U.S. Pat. Nos. 6,569,261; 6,593,288; 6,703,358; and 6,767,410, (Aubay et al.), each incorporated herein it its entirety by reference. If used in the present invention, these copolymers are incorporated at from about 0.01% to about 5% by weight actives, and more preferably from about 0.1% to about 1% by weight actives, based on the total weight of the acidic gel composition. Most preferred is to use Mirapol® Surf S-500 and/or Mirapol® Surf S-210 at from about 0.1% to about 1% by weight actives, based on the total weight of the composition.

A subgroup of copolymers that also comprise at least one quaternized monomer having general structure (I), and which are very useful in the present invention, are the copolymers formed from the copolymerization of monomer (I) with (a) an acid monomer selected from the group consisting of C₃-C₈ carboxylic, sulfonic, sulfuric, phosphonic or phosphoric acids, anhydrides, and salts thereof, and (b) a substituted (meth)acrylamide described by the general structure (II):

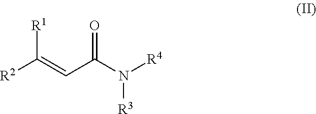

wherein R¹ is hydrogen or methyl;
R² is hydrogen or C₁-C₂ alkyl; and
R³ and R⁴ are independently C₁-C₈ alkyl.

Such polymers are disclosed in U.S. Patent Application Publications 2009/0324964 and 2010/0240563 (Jaynes et al.), both of which are incorporated herein by reference. Most typically the acid monomers are acrylic acid, methacryclic acid, maleic acid and 2-acrylamido-2-methyl-propane sulfonic acid (AMPS), either in free acid form or in any salt form. The two most useful copolymers in this subgroup for the present invention include: (A) a copolymer formed from the copolymerization of (a) any monomer having structure (I); (b) acrylic acid; and (c) dimethylacrylamide (i.e. formula (II) with R¹═R²═H and R³═R⁴=methyl); and (B) a copolymer formed from the copolymerization of (a) any monomer having structure (I); (b) acrylic acid; (c) dimethylacrylamide (i.e. formula (II) with R¹═R²═H and R³═R⁴=methyl); and (d) (meth)acrylamide. These copolymers are available from BASF under the Sokalan® brand name. The latter copolymer (B), comprising all four monomers, is available from BASF under the name Sokalan® ES-95062. If used in the present invention, these copolymers are incorporated at from about 0.01% to about 5% by weight actives, and more preferably from about 0.1% to about 1% by weight actives, based on the total weight of the acidic gel composition. Most preferred is to use Sokalan® ES-95062 at from about 0.1% to about 1% by weight actives, based on the total weight of the composition.

A second general class of copolymers that are very preferred for use in the present invention are the copolymers formed from at least one quaternized monomer having general structure (III):

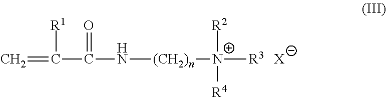

wherein R¹ is hydrogen or methyl;
R², R³ and R⁴ are independently lower alkyl, lower alkenyl, C₁-C₂₅ alkyl or aryl group, or: —CH₂CH(OH)CH₂—NR⁵R⁶R⁷⁺Y⁻, wherein R⁵, R⁶ and R⁷ are independently lower alkyls;
n is an integer from 1-6; and
X and Y (if present) are independently negatively-charged counterions such as halide, alkyl sulfate or aryl sulfonate.

The simplest monomer having general structure (III) is acrylamidopropyltrimethylammonium chloride, which is (III) with R¹=hydrogen; R², R³, and R⁴=methyl; n=the integer 3; and, X being chloride. Preferred copolymers are those having at least one monomer of structure (III) copolymerized with (meth)acrylic acid and, optionally, ethyl(meth)acrylate. The copolymers having all three monomer types are sometimes referred to as “hydrophobically modified amphoteric copolymers” because the acrylate ester monomer content increases the hydrophobicity of what is essentially an amphoteric copolymer created from a mixture of monomers having structure (III) and (meth)acrylic acid. These preferred copolymers having at least one quaternized monomer of structure (III) are disclosed in U.S. Pat. No. 4,495,367 (Dammann); U.S. Pat. No. 4,973,637 (Morgan et al.); U.S. Pat. No. 7,105,579 (Adam et al.); and in U.S. Application Publication Nos. US2006/0205827 (Deroo, et al.); and US2009/0107524 (Gross et al.) each of which incorporated herein by reference. Most preferred from this group of copolymers is acrylamidopropyltrimethylammonium chloride/sodium acrylate/ethyl acrylate copolymer, sold by Cognis under the trade name Polyquart® Ampho 149 and Polyquart® PRO, and a copolymer formed from acrylamidopropyltrimethylammonium chloride and sodium acrylate, available from Henkel as Polyquart® KE-3033. If used in the present invention, these copolymers are incorporated at from about 0.01% to about 5% by weight actives, and more preferably from about 0.1% to about 1% by weight actives, based on the total weight of the acidic gel composition. Most preferred is to use Polyquart® Ampho 149 and/or Polyquart® PRO at from about 0.1% to about 1% by weight actives, based on the total weight of the composition.

Microbially-Derived Polysaccharide

For improving the rinsing of an acidic gel cleaner it has been unexpectedly discovered that microbially-derived polysaccharidic polymers work exceptionally well in conjunction with one of the copolymers having a quaternized monomer described above. A number of polysaccharidic polymers are generated by microorganisms. Some examples include, but are not limited to, alginate, curdlane, dextran, diutan, gellan, glucan, pullulan, and xanthan. Xanthan gum is produced as an extra-cellular product in the fermentation of glucose or sucrose by the bacterium Xanthomonas campestris. Since the backbone of xanthan gum consists of two β-D-glucose units linked through the 1 and 4 positions, each monosaccharide unit in the backbone has two free hydroxyl groups (—OH groups). The side chains of the molecule consist of two mannose and one glucuronic acid monosaccharidic units. Some of these mannose units have a pyruvate ester linkage, but nonetheless, considerable numbers of free hydroxyl groups remain in the repeating side chains of the xanthan gum polymer as well as in the backbone. That being said, it appears that such a microbially-derived polysaccharidic polymer as xanthan gum is preferred for improving the rinsing of a dried-on acidic gel, perhaps due to the multitude of free hydroxyl groups available for rapid re-hydration of the dried cleaner. The most preferred microbially-derived polysaccharidic polymers to be used herein is xanthan gum available from CP Kelco under the trade name Keltrol RD®, Keizan S® and Kelzan T® and Kelzan AR®, or mixtures thereof. It is preferable to incorporate the microbially-derived polysaccharidic polymer at from about 0.01% to about 5% by weight in the acidic gel cleaner, based on the total weight of the cleaner composition. Most preferred is to use from about 0.1% to about 1% by weight of xanthan gum in the gel cleaner, based on the total weight of the composition.

The most marked improvement in rinsing and removal of dried-on cleaner is when the weight percent actives of copolymer having a quaternized monomer exceeds the weight percent actives of the microbially-derived polysaccharide polymer. The preferred ratio of copolymer to polysaccharide is from about 1.5:1 to about 2:1. For example, if the amount of copolymer is in the composition at a weight percent actives of about 0.8 wt. % to about 1.0 wt. %, then the amount of microbially-derived polysaccharidic polymer should be from about 0.4 wt. % up to about 0.7 wt. %.

### Optional Ingredients

Alkaline Buffers and Builders

The acidic gel cleaner of the present invention may also include alkaline buffering agents and/or builders that can double as a pH buffer because they are alkaline agents. Such alkali and alkaline builders may include but are not limited to carbonates, bicarbonates, silicates, borates, zeolites, phosphates, citrates, alkali metal hydroxides, alkaline earth hydroxides, amines, alkanolamines, and the like, at a level of from about 0.001% to about 5% by weight active material. More useful in the present invention is sodium, potassium or magnesium hydroxide, mono-, di-, or triethanolamine, or aminomethylpropanol (AMP). Most preferred is to use sodium hydroxide at from about 0.01% to about 2% by weight based on the total weight of the gel composition. Any of these alkaline materials are expected to react to some extent with the acids present in the composition, creating a distribution of free acid and corresponding salts. The pH of the final acidic gel cleaner is preferably less than about 3. Therefore the alkali builder acts as a pH buffer when used together with the acid in the present invention.

Solvents, Fragrance, Dye, and Preservatives

The compositions herein will incorporate at least 50% by weight water, and most preferably at least 80% by weight of water. Solvents may be optionally included in these compositions as is seen in the formulation of many residential and institutional hard surface cleaners. For example, alcohols (preferably lower molecular weight alkanols), glycols, and glycol ethers may be used as co-solvents for the present compositions. Solvents, particularly the glycol ether solvents pioneered by Dow Chemical and Union Carbide, allow dissolution of soils directly, and assist the surfactants in soil removal. Most preferred for use in the present invention are ethanol, isopropanol, propylene glycol, ethylene glycol n-butyl ether, propylene glycol n-butyl ether, propylene glycol mono-methyl ether, propylene glycol mono-phenyl ether, and propylene glycol dimethyl ether at from about 0.1% to about 5% by weight of the total composition.

The acidic gel cleaner compositions may include fragrance. It is desirable to add sufficient fragrance to the compositions to be perceived while cleaning and to impart at least a temporary scent after the surfaces are cleaned. This may require; the use of substantive fragrances that have an increased longevity due to the nature of the fragrance components themselves (i.e. at least some less volatile ingredients); the use of a fairly large amount of fragrance; and/or, the use of encapsulated fragrance(s), or combinations of these ideas. In the simplest embodiment, a fragrance typically used in cleaning compositions (e.g. lemon, orange, pine, floral, mint, etc.) may be incorporated in the detersive composition at from about 0.001% to about 5% by weight. At this level, some perceivable fragrance is likely to remain temporarily even after cleaning of the bathroom surfaces.

Encapsulated fragrances are well known in the art, and are preferred for use in the gel composition of the present invention to give the composition a longer-lasting fragrance in storage. Encapsulation of fragrance has been described in many prior art references, including but not limited to U.S. Pat. No. 7,338,928 to Lau et al.; U.S. Pat. No. 7,294,612 to Popplewell et al.; U.S. Pat. No. 7,196,049 to Brain et al.; U.S. Pat. No. 7,125,835 to Bennett et al.; U.S. Pat. No. 7,122,512 to Brain et al.; U.S. Pat. No. 7,119,057 to Popplewell et al.; U.S. Pat. No. 6,147,046 to Shefer et al.; U.S. Pat. No. 6,142,398 to Shefer et al.; U.S. Pat. No. 4,446,032 to Munteanu et al.; and, U.S. Pat. No. 4,464,271 to Munteanu, each of which is incorporated herein by reference. Fragrance encapsulation has been optimized and is available through various suppliers, most notably LIPO Technologies, Inc., Vandalia, Ohio, and Alco Chemical, Chattanooga, Tenn., (e.g. using Alcocap® natural polymers for encapsulation). Encapsulation is described thoroughly in “Microencapsulation: Methods and Industrial Applications”, Benita (Ed.), Marcel Dekker, Inc., New York, 1996. Fragrance microcapsules obtained from LIPO, Alco, or the fragrance houses, or as obtained through any of these published methods may be incorporated in the acidic gel compositions of the present invention herein at from about 0.001% to about 0.05% by weight of the composition.

The acidic gel cleaner compositions may also contain a colorant such as pigments or dyes. Colorants are chosen so that they are compatible with the other ingredients in the acidic composition, and not staining to grout, worn vitreous, and other porous surfaces that the cleaning product may encounter. For example, a preferred colorant for use in the present invention are Iragon® Blue ABL9 (from BASF) and Liquitint® Green FS (from Milliken), at from about 0.0001% to about 0.1% by weight active dye, based on the total composition. Other non-limiting examples of dyes include C.I. Pigment Green #7, C.I. Reactive Green #12, F D & C Green #3, C.I. Acid Blue #80, C.I. Acid Yellow #17, Liquitint® Red MX, F D & C Yellow #5, Liquitint® Violet LS, Fast Turquise GLL, Liquitint® Blue MC, Liquitint® Blue HP, or mixtures thereof, which are also useful in the acidic gel compositions of the present invention.

Other optional ingredients that may be included in the acidic gel composition include, but are not limited to, oxygen bleaching agents such as percarbonates, perborates, hydrogen peroxide, or organic peroxides, and the like, enzymes (such as proteases, amylases, lipases, and cellulases, and the like), other thickeners (surfactants and/or polymers), emulsifiers, enzyme stabilizers, inorganic or organic absorbents, clays, salts, abrasives, preservatives (Neolone® Kathon® Acticide®, and the like), and anti-foaming agents (silicones and the like).

Examples and Performance Data

Two exemplary embodiments of the acidic gel cleaner of the present invention are shown in TABLE 1 below. Each of the acidic gel cleaners were buffered to a final pH of about 2.5 to 2.7. Formula Nos. 1 and 5 are both “control” compositions, neither having any copolymer in the composition. The first set of four formulas (Nos. 1-4) incorporate Kelzan® AP as the microbially-derived polysaccharide, whereas the second set of formulas (Nos. 5-8) incorporate Kelzan® ASX-T as the microbially-derived polysaccharide.

TABLE 1
ACIDIC GEL CLEANERS WITH IMPROVED RINSING

| | Formulations | | | | | | | |
|---|---|---|---|---|---|---|---|---|
| Ingredient (wt. % actives) | 1 | 2 | 3 | 4 | 5 | 6 | 7 | 8 |
| Lactic acid | 4.50 | 4.50 | 4.50 | 4.50 | 4.50 | 4.50 | 4.50 | 4.50 |
| Sodium hydroxide | 0.30 | 0.30 | 0.30 | 0.30 | 0.30 | 0.30 | 0.30 | 0.30 |
| Alkyl benzene sulfonate | 4.50 | 4.5 | 4.5 | 4.5 | 4.5 | 4.5 | 4.5 | 4.5 |
| Alkyl polyglucoside | 1.00 | 1.00 | 1.00 | 1.00 | 1.00 | 1.00 | 1.00 | 1.00 |
| Polysaccharide (see notes) | 0.40a | 0.40a | 0.40a | 0.40a | 0.50b | 0.50b | 0.50b | 0.50b |
| Copolymer (see notes) | — | 0.80c | 0.80d | 0.80e | — | 0.80c | 0.80d | 0.80e |
| Dyes, fragrance, etc. | yes | yes | yes | yes | yes | yes | yes | yes |
| Water | q.s. | q.s. | q.s. | q.s. | q.s. | q.s. | q.s. | q.s. |
| Total | 100 | 100 | 100 | 100 | 100 | 100 | 100 | 100 |

Notes:
aKelzan AP;
bKelzan ASX-T;
cSokalan ES95062;
dMirapol Surf-S;
ePolyquart PRO

Rinsing Performance

The remarkable find here is that a polymer combination consisting essentially of a copolymer having at least a quaternized monomer and a microbially-derived polysaccharidic polymer greatly improves the ability to rewet and rinse away a dried-on mass of acidic gel cleaner from a hard surface.

Rinsing Test Method

This in-house test method uses new 10″×10″ white ceramic tiles that have not been previously exposed to surface modifying polymers. On each tile an 8″×8″ square area in the center is marked off. An 8.0 gram sample of the acidic gel cleaner to be tested is spread evenly within the marked square area, and the sample is allowed to air dry at ambient temperature for at least 8 hours (or overnight). The test tiles are then individually placed under a 100 ml/sec flow of cold tap water, with the tile moved back and forth laterally under the flow stream such that the flow of water cascades across the tile at all times. The time it takes to remove approx. 99% of the dried-on gel cleaner is measured. Since there are always very small pieces of the dried on mass that won't be removed, the timing is recorded only up to about 99% removal of the dried mass. Lower rinse times indicate better formulas and indicate the ability to easily remove dried-on gel cleaner from a hard surface. The rinse times are set out in TABLE 2 below.

TABLE 2
RINSE TIMES FOR GEL CLEANERS DRIED ON TILES

| | Formula (from TABLE 1) | | | | | | | |
|---|---|---|---|---|---|---|---|---|
| | 1 | 2 | 3 | 4 | 5 | 6 | 7 | 8 |
| Copolymer/polysaccharide | n/a | 2.0 | 2.0 | 2.0 | n/a | 1.6 | 1.6 | 1.6 |
| Rinse time (sec) | 36 | 11 | 9 | 7 | 24 | 11 | 9 | 8 |

Analysis of the results in TABLE 2 reveal that the presence of only polysaccharidic polymer (Formula Nos. 1 and 5) does not significantly aid in the removal of a dried-on mass of gel cleaner compared to the use of a synergistic combination of polysaccharidic polymer and copolymer having quaternized monomers (Formula Nos. 2-4 and 6-8). Additionally, for both sets of test formulas, the acrylamidopropyltrimethylammonium chloride/sodium acrylate/ethyl acrylate copolymer, (hydrophobically modified amphoteric copolymer Polyquart® PRO from Cognis) gave slightly faster rinse removal times than diallyldimethylammonium chloride/acrylamide/acrylic acid copolymer (Mirapol® Surf-S from Rhodia) and the copolymer formed from the copolymerization of a DADMAC-type monomer with acrylic acid, dimethylacrylamide, and (meth)acrylamide, (Sokalan ES95062 from BASF), although the results are very close. Clearly there is a synergistic effect when combining a copolymer having a quaternized monomer such as (I) or (III) with a polysaccharide that greatly improves the ability to rinse and remove a dried-on mass of acidic gel cleaner from a hard surface.

Cleaning Performance

The cleaning performance of the acidic gel cleaners of the present invention were tested using industry standard test methods. Cleaning performance on soap scum soil was measured using both the CSPA and ASTM methods. Cleaning performance on grease soil was measured using the TDC1084 test method. Three retail products were used as benchmarks, Soft Scrub® Gel with Bleach (Henkel Corp), Soft Scrub® Total™ Bath & Bowl Cleaner (Henkel Corp), and a competitive acidic bathroom cleaner (labeled here as “Retail Cleaner 1”). The results of the cleaning tests are shown in TABLE 3 below.

TABLE 3
CLEANING PERFORMANCE OF ACIDIC CLEANERS

| | Cleaning Performance | | |
|---|---|---|---|
| | (percent % soil removal) | | |
| | Soap | Soap | |
| Acidic Cleaner | Scum | Scum | Grease |
| (Retail product or TABLE 1 formula) | (CSPA) | (ASTM) | (TDC1084) |
| Soft Scrub ® Gel with | 57 | 38 | 17 |
| Bleach Cleanser | | | |
| Soft Scrub ® Total ™ Bath & Bowl | — | 38 | 17 |
| Retail Comp 1 | — | 32 | 15 |
| Formula 1 | 40 | 63 | 32 |
| Formula 2 | — | 53 | 32 |
| Formula 3 | | 52 | 32 |
| Formula 4 | | 53 | 31 |
| Formula 5 | 44 | 42 | 22 |
| Formula 6 | 43 | 54 | 27 |
| Formula 7 | 57 | 49 | 29 |
| Formula 8 | 31 | 43 | 24 |

As shown in Table 3, in all but one of the tests (Soft Scrub® Gel in the CSPA test), the compositions in accordance with the present invention, namely Formula Nos. 1-8, show better cleaning performance than the three existing retail products in the test. For example, Formula No. 1 shows 63% soil removal in the ASTM soap scum test as compared to 38% soil removal for Soft Scrub® Gel with Bleach Cleanser. However, when comparing an acid gel cleaner only having polysaccharidic polymer, such as Formula No. 1, to compositions having both the same polysaccharide polymer and one of the preferred copolymers, namely Formula Nos. 2-4, there appears to be a small reduction in cleaning performance. That same trend is not followed when comparing the cleaning performance of Formula 5 (only a polysaccharide polymer) to Formulas 6-8 (polysaccharide polymer plus a copolymer).

The present invention also comprises a method for improving the rinsing characteristics of an acidic gel cleaner comprising acid, surfactant, and water. An acidic gel cleaner, such as a bathroom cleaner, will be very difficult to rewet and rinse off from a hard surface if it has been inadvertently dried onto that surface. In theory, any existing acidic gel cleaner comprising acid, surfactant, and water, such as any of the existing acidic bath and bowl cleaners, could benefit from the addition of the present inventive combination of polymers. Such modification would ensure that the acidic gel cleaners could be easily removed if dried onto a surface, for example when the consumer is distracted from the cleaning chore and the product happens to dry out on the hard surface. Therefore, the present invention is also a method for improving the rinsing characteristics of an acidic gel cleaner comprising acid, surfactant, and water, said method comprising the steps of: (a) providing a mixture of acid, surfactant and water; and (b) adding to the mixture a synergistic blend of polymers consisting essentially of (i) at least one copolymer having at least one quaternized monomer and (ii) at least one microbially-derived polysaccharidic polymer.

We have thus shown that the combination of a copolymer having at least one quaternized monomer and a microbially-derived polysaccharidic polymer dramatically improves the rinse/removal times for acidic gel cleaners dried onto hard surfaces. In particular, combinations of (a) a copolymer having at least (i) a DADMAC type or (ii) an acrylamidopropyltrimethylammonium chloride type monomer and (b) a xanthan gum, dramatically improves the rinsing performance of an acid cleaner comprising acid, surfactant and water, allowing the product to be rinsed and removed from a hard surface even after the product is dried on a surface.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. An acidic gel composition comprising:
a) an acid;
b) a surfactant chosen from the group consisting of anionic surfactants, nonionic surfactants, amphoteric surfactants, and mixtures thereof;
c) water; and
d) a combination of two polymers consisting essentially of:
i) from about 0.1 wt. % to about 1.0 wt. % of a copolymer having at least one quaternized monomer; and
ii) from about 0.1 wt. % to about 1.0 wt. % of a microbially-derived polysaccharide;
wherein the weight percent ratio of (i) copolymer to (ii) microbially-derived polysaccharide is from about 1.5:1 to about 2:1.

2. The composition of claim 1, wherein said quaternized monomer is selected from the group consisting of:
a) monomers having general structure (I) 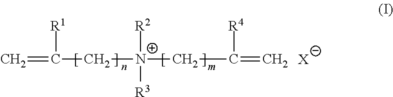
wherein R¹ and R⁴ independently represent a hydrogen atom or a linear or branched C₁-C₆ alkyl group;
R² and R³ independently represent an alkyl, hydroxy alkyl, or amino alkyl group, in which the alkyl group is a linear or branched C₁-C₆ chain;
n and m independently represent integers between 1 and 3; and
X represents a negatively-charged counterion,
b) monomers having the general structure (III) 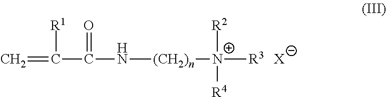
wherein R¹ is hydrogen or methyl;
R², R³ and R⁴ are independently lower alkyl, lower alkenyl, C₁-C₂₅ alkyl or aryl group;
n is an integer from 1-6; and
X represents a negatively-charged counterion,
and mixtures thereof.

3. The composition of claim 1, wherein said copolymer is formed from the copolymerization of:
a) monomers having general structure (I) 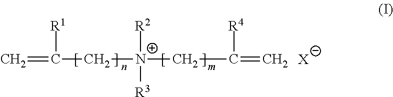
wherein R¹ and R⁴ independently represent a hydrogen atom or a linear or branched C₁-C₆ alkyl group;
R² and R³ independently represent an alkyl, hydroxy alkyl, or amino alkyl group, in which the alkyl group is a linear or branched C₁-C₆ chain;
n and m independently represent integers between 1 and 3; and
X represents a negatively-charged counterion;
b) at least one hydrophilic monomer having an ionizable acid functionality; and,
c) optionally, at least one hydrophilic monomer having olefinic unsaturation and overall neutral charge.

4. The composition of claim 1, wherein said copolymer is formed from the copolymerization of:
a) monomers having general structure (I) 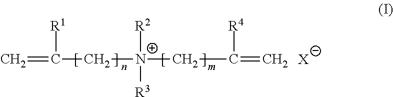
wherein R¹ and R⁴ independently represent a hydrogen atom or a linear or branched C₁-C₆ alkyl group;
R² and R³ independently represent an alkyl, hydroxy alkyl, or amino alkyl group, in which the alkyl group is a linear or branched C₁-C₆ chain;
n and m independently represent integers between 1 and 3; and
X represents a negatively-charged counterion;
b) at least one acid monomer; and
c) a substituted (meth)acrylamide described by the general structure (II): 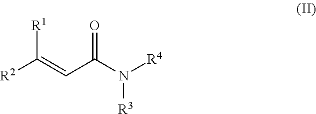
wherein R¹ is hydrogen or methyl;
R² is hydrogen or C₁-C₂ alkyl; and
R³ and R⁴ are independently C₁-C₈ alkyl.

5. The composition of claim 1, wherein said copolymer is selected from the group consisting of diallyldimethylammonium chloride/acrylamide/acrylic acid copolymer, diallyldimethylammonium chloride/acrylic acid/dimethylacrylamide/(meth)acrylamide copolymer, acrylamidopropyltrimethylammonium chloride/sodium acrylate/ethyl acrylate copolymer, and mixtures thereof.

6. The composition of claim 1, wherein said microbially-derived polysaccharide is xanthan gum.

7. The composition of claim 5, wherein said microbially-derived polysaccharide is xanthan gum.

8. An acidic gel cleaner composition consisting essentially of:
a) from about 0.5% to about 10% by weight of the total composition of an organic acid selected from the group consisting of citric acid, lactic acid, and mixtures thereof;
b) from about 0.1% to about 5% by weight of an anionic surfactant, based on the total weight of said composition;
c) from about 0.1% to about 5% by weight of a nonionic surfactant, based on the total weight of said composition;
d) at least about 80% by weight water, based on the total weight of said composition;
e) from about 0.1% to about 1% by weight of the total composition of a copolymer selected from the group consisting of diallyldimethylammonium chloride/acrylamide/acrylic acid copolymer, diallyldimethylammonium chloride/acrylic acid/dimethylacrylamide/(meth)acrylamide copolymer, acrylamidopropyltrimethylammonium chloride/sodium acrylate/ethyl acrylate copolymer, and mixtures thereof;
f) from about 0.1% to about 1% by weight of the total composition of a microbially-derived polysaccharide selected from the group consisting of alginate, curdlane, dextran, diutan, gellan, glucan, pullulan, xanthan, and mixtures thereof;
wherein the weight percent ratio of said copolymer to said microbially-derived polysaccharide is from about 1.5:1 to about 2:1.

9. A method for improving the ability to rinse off an acidic gel cleaner dried onto a hard surface, said cleaner comprising acid, surfactant, and water, said method comprising the steps of:
a) providing an acidic mixture of acid, surfactant, and water; and
b) adding to said mixture a combination of two polymers consisting essentially of:
i) from about 0.1 wt. % to about 1.0 wt. % of a copolymer having at least one quaternized monomer; and
ii) from about 0.1 wt. % to about 1.0 wt. % of a microbially-derived polysaccharide;
wherein the weight percent ratio of (i) copolymer to (ii) microbially-derived polysaccharide is from about 1.5:1 to about 2:1.

10. The method of claim 9, wherein said copolymer is selected from the group consisting of diallyldimethylammonium chloride/acrylamide/acrylic acid copolymer, diallyldimethylammonium chloride/acrylic acid/dimethylacrylamide/(meth)acrylamide copolymer, acrylamidopropyltrimethylammonium chloride/sodium acrylate/ethyl acrylate copolymer, and mixtures thereof.
